(19) United States
(12) Patent Application Publication
(10) Pub. No.: US 2015/0347975 A1
(43) Pub. Date: Dec. 3, 2015

(54) SYSTEM AND METHOD FOR CREATING AND DISSEMINATING ONLINE JOB DESCRIPTIONS

(71) Applicant: Ongig, Inc., San Francisco, CA (US)

(72) Inventors: Robert Kelly, Oakland, CA (US); Jason Webster, San Francisco, CA (US); Kevin Lanik, San Francisco, CA (US)

(21) Appl. No.: 14/721,219

(22) Filed: May 26, 2015

Related U.S. Application Data
(60) Provisional application No. 62/003,677, filed on May 28, 2014.

(51) Int. Cl. G06Q 10/10

(52) U.S. Cl. CPC G06Q 10/1053; G06Q 50/01

(57) ABSTRACT

The present invention embodiments pertain to an online recruiting system, method, and computer program product for creating, disseminating, and measuring dynamic job descriptions. The embodiments of the present invention described herein are designed to compel candidates to interact with brands and apply for advertised positions. The system is designed as an intelligent system for users to create a seamless, end to end, dynamic talent acquisition experience. The system is utilized to create dynamic job descriptions, and/or power a dynamic branded, often referred to as “white-labeled”, full scale career site. Job(s) (or job objects) may be represented by stand-alone dynamic job descriptions, employer brand pages, and/or dynamic branded full scale career sites. Users create their branding (e.g., colors, logos etc.), manually or by linking their programmed styles, and integrate their systems/networks to automate as much of job postings as they so choose.

### CROSS-REFERENCE TO RELATED APPLICATIONS

This application claims priority from U.S. Provisional Patent Application Ser. No. 62/003,677, entitled “System and Method for Creating and Disseminating Online Job Descriptions” and filed on May 28, 2014, the disclosure of which is incorporated herein by reference in its entirety.

### BACKGROUND

An ultimate goal in recruiting is for employers to find the most qualified candidates, or candidate pool, in the most efficient manner possible. The Internet and, more specifically, networks making up the “social” Internet, have transformed the way companies source, screen, communicate with, and track potential candidates. The recruiting process involves several steps, from defining the job in need of being filled, to sourcing the prospective candidates, filtering through candidate data, screening the candidates and coming to an ultimate hiring decision.

There are several methods a company or other recruiter can use in the talent acquisition or other recruiting process. A lot of companies have a recruiting staff, or utilize their Human Resource (HR) departments, for their talent acquisition needs. Additionally, some companies enlist the help of outside recruiters, or agencies. There are different types of agencies that assist in talent acquisition efforts. Executive recruiting firms source for executive, and C-Level positions. Employment agencies may source for permanent or temporary positions, and can deal with the lower skill level to very high level niche skills. There are also Internet recruiting firms which utilize the Internet to assist companies in sourcing with a wider reach. In addition, there is social media recruiting. Social media recruiting can be used by any of the aforementioned methods/firms, primarily to target specific groups, or individuals, to either fill the position themselves or drive referrals within their networks.

In the early to mid 1900's, a job seeker literally went door to door in search of his/her next job. Possibly, in response to a “wanted” advertisement placed in a newspaper or periodical. Fast forward to the 1990's, and the early versions of the “job board” (e.g., MONSTER—1994), as well as corporate career sites, began to surface. Unfortunately, these sites were incredibly tough to find, and even more difficult to navigate. Basically, a job seeker could search multiple jobs at once, visit the employer's website with a click and email the employer if they wanted to apply. With the advent of social networks in the early 2000's, a great paradigm shift occurred in the space of talent acquisition. There has been an evolution from times where the job seeker demonstrated why they were the one for the job, and the “passive” candidate was next to impossible to find, to a time where the onus is largely on the employer to create an image that attracts the top talent to them.

There are two main channels in the online recruiting space. First, there are the destination channels that are designed for the candidates to find them. Destination channels can consist of items, such as company career sites and pages, brand profiles, online communities, blogs, etc. Second, there are distribution channels that are designed for the employer, recruiter, job, etc. to find it's way in front of the candidate. Distribution channels use platforms, including online/social networks, as a resource for distributing jobs or having people, and influencers, share the information (e.g., crowd-sourcing). These two channels are not mutually exclusive, but regardless of the channel, the end result is always for the candidate to view something online from the employers providing details on the specific job for which they are hiring.

However, the candidates end up viewing the traditional job description. The traditional job description consists of a bunch of text explaining the requirements of the position, education/experience required, benefits etc., and typically links to the application process or an email to the company. This has been the case for the last several years, where the traditional job description has not changed. Although the manners of distribution have evolved, the actual job description has failed miserably to keep up. The attributes the traditional job description historically lacks include: the name of the job owner (or recruiter responsible for filling the job), where the job description does not create a seamless manner with which to communicate with the job owner; visuals, such as pictures and videos; social connectivity; not being designed as “shareable”; no direct interaction and/or feedback loop; and not being designed as interactive, living descriptions.

### SUMMARY

The present invention embodiments pertain to an online recruiting system, method, and computer program product for creating, disseminating, and measuring dynamic job descriptions. The embodiments of the present invention described herein are designed to compel candidates to interact with brands and apply for advertised positions (e.g., of employment or jobs). The system is designed as an intelligent system for users to create a seamless, end to end, dynamic talent acquisition experience. The system is utilized to create dynamic job descriptions, and/or power a dynamic branded, often referred to as “white-labeled”, full scale career site. Job(s) may be represented by stand-alone dynamic job descriptions, employer brand pages, and/or dynamic branded full scale career sites. Users create their branding (e.g., colors, logos etc.), manually or by linking their programmed styles, and integrate their systems/networks to automate as much of job postings as they so choose.

This intelligent, automated, system dramatically changes the way job(s) are created, look and feel. No longer does one need to spend countless hours tediously crafting a job description, only to produce an unappealing, static, text based product that resides in a singular place. With embodiments of the present invention, users can now easily automate the job(s) creation process, deliver an end product that brings the jobs(s) to life and quickly distribute job(s) amongst various platforms, communities and advertising spaces.

### BRIEF DESCRIPTION OF THE DRAWINGS

FIG. 1 is a diagrammatic illustration of an example computing environment according to an embodiment of the present invention.

FIG. 2 is a flow diagram illustrating a manner in which to create a media library according to an embodiment of the present invention.

FIG. 3 is a flow diagram illustrating a manner in which to link an applicant tracking system (ATS) according to an embodiment of the present invention.

FIG. 4 is a flow diagram illustrating a manner in which to create job(s) (e.g., career pages, full scale career sites and job specific pages) and employ intelligent media matching according to an embodiment of the present invention.

FIG. 5 is a flow diagram illustrating a manner in which to add co-creators to job(s), and provide corresponding notifications according to an embodiment of the present invention.

FIG. 6 is a flow diagram illustrating a manner in which to link networks to job(s) according to an embodiment of the present invention.

FIG. 7 is a flow diagram illustrating a manner in which to interactively comment/post, and provide corresponding notifications according to an embodiment of the present invention.

FIG. 8 is a flow diagram illustrating a manner in which to track companies, hiring managers, or job(s), and provide corresponding notifications according to an embodiment of the present invention.

FIG. 9 is a flow diagram illustrating a manner in which to join a talent network and utilize the talent network for disseminating information according to an embodiment of the present invention.

FIG. 10 is a flow diagram illustrating a manner in which to share information according to an embodiment of the present invention.

FIG. 11 is a flow diagram illustrating a manner in which to provide a competition and display an online/social sharing leaderboard according to an embodiment of the present invention.

FIG. 12 is a flow diagram illustrating a manner in which to disseminate, or syndicate, job(s) to other job boards or outlets according to an embodiment of the present invention.

FIG. 13 is a flow diagram illustrating a manner in which to provide job analytics according to an embodiment of the present invention.

FIG. 14 is a flow diagram illustrating a manner in which to create an advertisement according to an embodiment of the present invention.

### DETAILED DESCRIPTION OF EXAMPLE EMBODIMENTS

The present invention embodiments pertain to an online recruiting system, method, and computer program product for creating, disseminating, and measuring dynamic job descriptions. A present invention embodiment may include one or more of the following features.

The system may be designed to integrate and automate job postings. Users create dynamic job descriptions, branded company pages, and/or power entire career sites all from one central hub on an automated system. Users brand their job(s) to ensure the design and layout match the company's requisite specifications/branding. Users can manually create their branding, or they can link styles currently programmed outside the system (e.g., linking Cascading Style Sheets (CSS), style sheets, files, etc.). Once a job is branded, users connect it to their various networks, systems and repositories, which allows the system to automate the importing of job information, and media content to be placed in the job description.

The system may allow users to co-create jobs. Multiple people on a hiring team (as many as needed) can create, and work on, job(s) together through the system. This allows for multiple collaborators to work on the same job(s) at the same time. The hiring manager can set permissions for the collaborators which are specific to the job(s) (e.g., full authority, review only, edit capabilities, task specific edit capabilities, etc.). Co-creation allows for, among other things, the ability to pass job(s) back and forth, assign tasks, request a review (e.g., crowd-sourcing), source content/media from others and set priority levels.

The system may include a notification system for collaborators sharing job(s). Users can enable/set various types of notifications as well as their desired notification method and timing (e.g., push or pull; email, text etc., and real time or scheduled summaries) for when there is new content/media added, media is uploaded to the library for potential use, a task is assigned, something requires review/edits, etc. Also, the notification sender can display priority levels within the notification itself.

The system may allow users to quickly and easily build out any form of a branded page. From a company's landing page, to an individual job's page, to a full scale career site powered by the system, users can build them all through a simple feature selection (e.g., drag and drop) interface. Users create the page, job posting or career site by determining what content, and features, they will include. Users can choose from existing templates, or create their own template to be applied. The process for creating these job(s) (or job objects) can be done manually, or via the automated system. Depending on the type of page being built, users will incorporate content and features including, but not limited to, information on the company, number of jobs to be listed per page (this is typically chosen when building a full scale career site), information describing the job, information and/or pictures of the job owner/co-owners/responsible parties (preferably hiring manager(s)), links, pictures, videos, audio and other media content, commenting/posting sections, online/social connections to the company, sharing buttons, and embed buttons. Once the page's templates are laid out, users simply link their branding, and the system imports the users styles (e.g., Cascading Style sheet files or any other style language) to be applied.

The system may allow users to build out a robust media library, housing all of their media content (e.g., pictures, video, audio etc.). Users connect their networks (e.g., FACEBOOK, INSTAGRAM, LINKEDIN, TWITTER, etc.) and files/drives (online and offline) to pull the content from. Users set the library to automatically pull, or manually upload, media content from the connected sources, and either apply these settings to all sources or set their preference source by source. Users can also log into the system and quickly record a video from their computer, tag and immediately incorporate into specific jobs, categories or the media library. Users are further able to create a sorting/filing system within their library to assist in identifying uploaded content (e.g., users can sort the media files by location, category, position and other attributes). With the system's tagging feature, users are able to assign specific keywords or phrases to further refine their media library content identification. Sorting and tagging makes the media content easily identifiable and searchable for later retrieval.

Users may link the system to their applicant tracking system (ATS), which may include any type of job database/repository the company uses. The system automatically creates new job(s) when they are added to the company's applicant tracking system. The system then automatically imports the job content and details added to the company's applicant tracking system, and inputs the data into the job(s) created.

The system may include an intelligent media matching (IMM) feature. This scans, and analyzes, the content within job(s), and cross-references that content with media in the library based on the filing and tagging applied to the media. Based on results from cross referencing, the IMM recommends and inputs media content into the job(s). Users can enable/set preferences allowing the IMM to automatically choose the media, based on parameters set (e.g., number and type of media pieces, such as six pictures and two videos, recency, relevance of files and tags, etc.), to use with the job(s). Alternatively, users can manually input media content into the job(s) based on recommendations made by the IMM, or directly from a search within the media library itself.

User may also quickly create specific pages of jobs based on specific criteria by appending their URL with a certain syntax. For instance, if a user is at a job fair, and wants to quickly pull together a new page with jobs postings in that certain city, they can do so by typing in a specific URL and the page is pulled together on the fly. As an example, if a user's URL is company.companyname.com, and the user wants to create a page that quickly aggregates jobs in a certain city, they user would append the above URL with the following, company.companyname.com/recruiting/city/cityname. Further, the page is pulled together with a sign in feature allowing users to collect information from candidates that sign in in real time. Users can sign in with a manual input or with any social media account (e.g., FACEBOOK, LINKEDIN, TWITTER, INSTAGRAM, etc.). A folder is then created on the back end in the users account with the sign in information for later retrieval.

Users may link their online/social networks (e.g., FACEBOOK, LINKEDIN, TWITTER, INSTAGRAM, etc.) to the system, and job(s). Connecting online networks to the job(s) allows the user to display connections people have to the company and/or position and/or hiring manager. Users are able to message their network connections, who are linked to the job, through the system. Also, users can request a connection, or direct a message, to the hiring manager(s) through the system if that functionality is turned on.

The system may include an interactive comment (e.g., commenting, posting, Q&A, etc.) feature addable to job(s). People can communicate directly with the hiring manager, or other system users, right on the job(s) through this feature. The system allows hiring managers, and users, to turn on notifications so they are alerted via their desired communication medium, in real time or in a summary message, when a new comment is posted to the job(s), and can respond if necessary or desired. Further, the system may allow users to create group chats. The group chats allow the hiring manager to set specific dates/times where candidates can sign in and interact directly with the hiring manager and one another.

The system may allow users to track job(s), companies or specific hiring managers. Further, users can send recommendations to track specific companies, hiring managers or job(s) to others. Those receiving the recommendation can follow the link within the message to review the suggestion, and can elect to follow the recommendation directly from the message or from the linked destination. This feature also allows for notifications. Users can enable/set various types of notifications as well as their desired notification method (e.g., push or pull, email, text etc., real time or scheduled summaries) when there is new content posted by those that they are tracking.

The system may allow users to build a talent network. These talent networks are designed to allow companies to engage specific users with relevant content and/or messages on a real time basis. Users simply click a button to join a company's talent network. The system, and talent network owners, then organize the users in the talent network by resume, background, skills etc. to make the talent network searchable by keywords that are matched with the aforementioned attributes. Further, the system can make recommendations, based on information known about users through their social or other networks and profiles, to both companies and users with appropriate users and talent networks respectively to join. Talent network owners create folders, in which to place users, based on their demographics. The system allows the talent network owners to create things, such as message campaigns centered around these talent networks. The talent network owners select those folders to initiate a message campaign, which pushes relevant content to specified user groups. These messages can be sent to the users through a variety of media (e.g., email, texts, online/social network messaging, etc.), and the system allows the users to elect how they receive their messaging (e.g., real time, summary, etc.).

The system may include online/social sharing functionality. Users can distribute job(s) quickly through the system. Users can disseminate job(s) across a variety of outlets including, but not limited to, online/social networks (e.g., direct messages, mass messaging, posts, etc.), email, mobile (e.g., Short Message Service (SMS), Multimedia Messaging Service (MMS), etc.), or through a job(s) embed feature. Further, certain platforms have specified templates multi-media sharing posts (e.g., TWITTER cards). In such cases, the system will use its analytics and tags to either suggest, or automatically populate, these multi-media sharing posts. Users can also quickly ask, or recommend, a job be shared with other people's social networks. The user simply shares the job with someone and a message is sent with embedded links to quickly share the job from within the message throughout a user's social networks (e.g. FACEBOOK, LINKEDIN, TWITTER, INSTAGRAM, etc.). For instance, if a user wants to drive more traffic to a particular job, he/she can share the job with colleagues etc., asking them to disseminate through their social networks.

The system may include a gamification or competition aspect. The system tracks how many times a user shares any Web page by any media techniques (e.g., online/social internet, email, text, etc.). This allows users to build a competitive, incentivized, sharing landscape that demonstrates a user's reach and influence through, as an example, a leader-board ranking of sharers. Users can further segment the sharers into categories (e.g., employees, followers, recruiters, etc.).

The system may allow for job(s) to be syndicated/disseminated across various participating, or open, platforms. The dissemination functionality allows for the system to act as a hub to either automatically, or manually, post job(s) to other job boards or platforms. Users can select specific platforms or all of the available outlets to distribute their job(s).

The system may also provide an analytics dashboard for the job(s). The system tracks, and displays, data on key calls-to-actions or other goals set by the users such as, but not limited to, applications, talent network joins, comments, time spent on job(s) pages, video plays, image views, online/social connections (reach) of visitors to the job(s), follows, online/social shares, etc. Also tracked is demographic data and behavior (e.g., mobile, desktop, laptop, browser, geography, time spent on job(s) or specific parts of the page such as video, traffic source, etc.). The analytics also contain specific track to hire data. The system tracks all traffic to job postings, online and offline, and allows user to view trend-line rankings of where conversion to applications and hires originates from. The system tracks online traffic and then looks at data from the application tracking system (e.g., did they apply?, did they interview?, did they get hired?) to give a complete picture of where candidates began and where they ended. This data allows users to determine and refine where their recruiting efforts/dollars are best spent. Users can measure, track and view their analytics on an aggregated basis (e.g., all job(s)) or on an individual job(s) basis. Users can further isolate specific trend-lines, by using keywords and date ranges. For instance, if a user wants to isolate and view the social sharing trend for a certain date range he/she can easily do so. Users can enable/set various types of notifications, and establish permissions for who has access to various levels of the analytics. Further, users can set preferences for their desired notification method and timing (e.g., push or pull, email, text, etc., real time or scheduled summaries) when there is new analytic data requiring attention/action, or for review.

The system may include an integrated and automated ads (advertisement) creation component for job(s). The system allows users to, with the click of a button, publish advertisements for their company and/or job(s) across various advertisement platforms. The system has external advertisement platform templates pre-programmed (e.g., the allowable number of characters of text, type/number/size of media files such as video and pictures etc.), which enables users to create, and publish, advertisements quickly utilizing existing content from their job(s). Therefore, users simply select the advertisement platforms to use, and the system then has an automated process for creating, and publishing the advertisements. Users can also manually select the content if they so choose. The automated process intelligently utilizes the system's analytics to suggest content for the advertisements (e.g., the system will use the pictures that people have viewed the most, etc.).

The present invention embodiments provide several advantages. The system presented is designed to streamline the currently arduous traditional online recruiting process by transforming both the system used in creating job(s) as well as the final product of the job(s) themselves. The system allows the job(s) creation process to be streamlined by linking the system to the user's applicant tracking system (ATS), and automatically pulling in the job(s) content. Further, the ability to add collaborators, set permissions and notifications enables users to crowd-source and tap into the collaborator's knowledge/skills, making use of more company resources. Collaboration will ultimately increase both productivity and creativity. In addition, the intelligent media matching (IMM) is an innovative way to store, and categorize, one's media content for later retrieval and use. The intelligent mapping of media content to the job(s) content streamlines and automates the process for bringing job(s) to life. The media content is intelligently matched with the descriptive content, pulled in from the ATS or manually input, of the job(s) and placed into the job(s) based on certain criteria.

The present invention embodiments also transform traditional job(s) from the current text based job description to more social, visual and live job(s), offering a realistic view into the position and company. Users upload pictures and video, along with descriptive content, depicting what it is like to work for that company in a specific position. Further, the commenting/posting functionality also allows people to interact with the hiring manger(s) in real time. Linking one's online networks allows for online/social mapping to be displayed, which instantly allows a user to build a more meaningful connection to the job(s). Online/Social linking enables users to quickly interact with those connected to the job(s) as well. Users can also share the job(s) amongst their networks expeditiously, and the ability to gamify that functionality creates incentive to do so. Further, the system's talent networks enable the recruiters to target specific groups, and engage them with relevant messaging/content in real time.

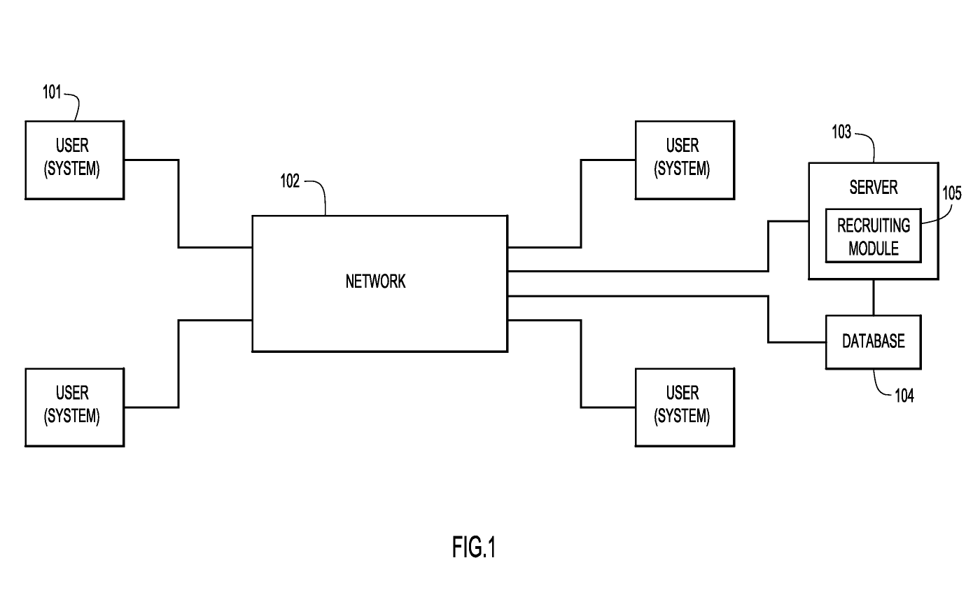

An online recruiting system according to an embodiment of the present invention is illustrated in FIG. 1. Specifically, the system users (or end-user systems) 101 are all connected to a central network 102. System users are typically connected to the system through personal computers (or other end-user systems or devices). The system includes a server computer system 103 within or in communication with network 102. The server computer system includes software that (in combination with server computer system 103) handles system user requests and basically implements the online recruiting system as described below. The software preferably utilizes Software as a Service (SAAS) to provide the functionality as a service to a remote user. The software may include one or more modules (e.g., recruiting module 105, etc.) to implement the various functions of the online recruiting system described below, and may reside within memory of the server and/or end-user systems for execution by a corresponding processor.

The server computer system includes or is in communication with a database 104 for storage of user and/or system information. The personal computers (or end-user systems) and server computer systems may be implemented by any conventional computer or other processing systems or devices. For example, the conventional or other computer systems may be equipped with a display or monitor, a base (e.g., including at least one processor, one or more memories and/or internal or external network interfaces or communications devices (e.g., modem, network cards, etc.)), optional input devices (e.g., a keyboard, mouse or other input device), and any commercially available and custom software (e.g., server/communications software, recruiting module, browser/interface software, etc.).

The online recruiting system allows users to streamline the process for branding the job(s) and inputting the information and media that brings the job(s) to life. The system allows users to create job(s) on an individual basis, branded company pages, and/or power their entire career site with the system representing all of their current job openings. Users can automate the entire job(s) (or job object) creation process or manually execute any, or all, of the system functions/components.

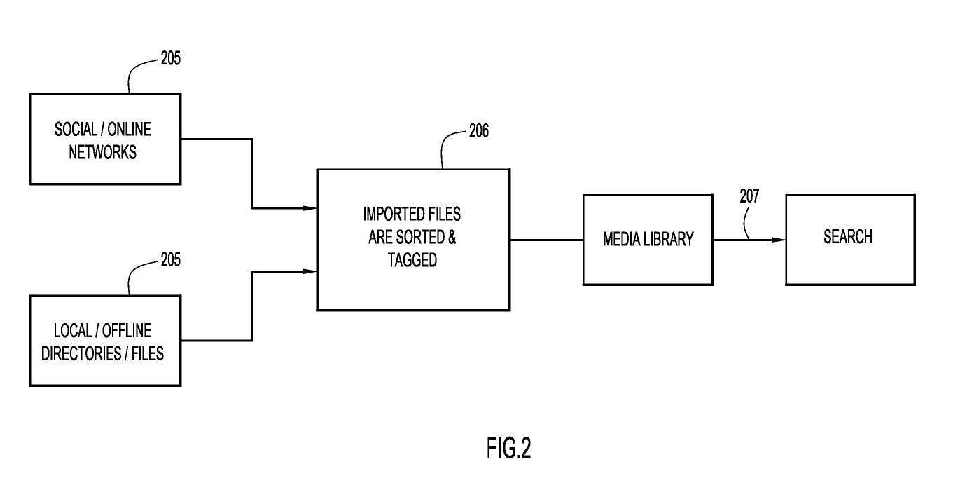

A robust media library may be constructed as illustrated in FIG. 2. Users link their online/social networks, and local/offline file directories at step 205. Particularly, the system will search within those networks, and files, and identify media files (e.g., pictures, videos, audio etc.) to pull into the media library (e.g., preferably hosted on database 104). The process of uploading files from the connected sources can be done automatically or manually. Users can set preferences to determine what will be uploaded automatically and either apply these settings to all sources or set their preference source by source. Within the media library users will create a sorting/filing system, where they sort and tag the individual files at step 206. Users can sort the media files by location, category, position and any other attributes necessary. This allows for quick search and retrieval by either the user or the automated system at step 207. In addition, users can log into the system, quickly record a video (or other object) from their computer, tag the video, and immediately incorporate the video into specific jobs, categories, or the media library.

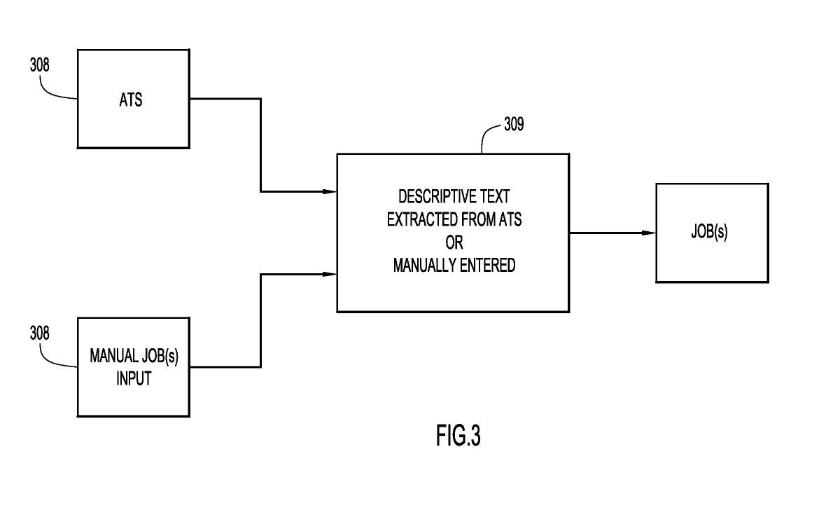

An applicant tracking system (ATS) (e.g., including a job database/repository with job listings) may be linked to the system as illustrated in FIG. 3. Linking the ATS to job(s) shown at step 308 allows the job(s) details, and information, to be fed directly into the job(s) fields at step 309. Users can either set the system to automatically pull all job(s) entered into the ATS into the system's job(s), or users can select which specific job(s) to feed from the ATS to the system's job(s). Alternatively, users can manually input the job(s) information at step 308 into the system's job(s) at step 309.

Clients may export data from their applicant tracking system (ATS) to be imported into a back-end database very quickly. Every ATS has a different data export format (e.g., CSV, SQL, etc.), and the system import tool intelligently determines which ATS (or data export format) is importing the data based upon the data structure. Front-end data of the system is connected with the ATS export to show a user the entire recruiting funnel. The system is further designed with the ability to run multiple parallel, and separate, queries to a user candidate database (i.e., their ATS). This allows the system to locate and process information quickly, even from multiple sources for quick retrieval.

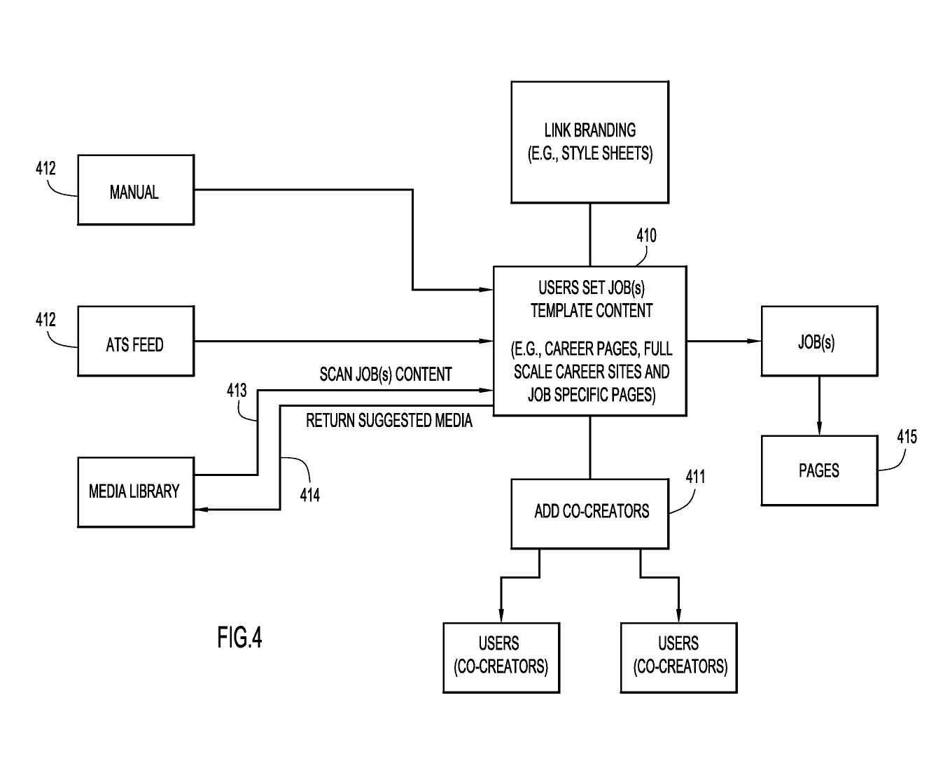

The job(s) creation process incorporates the system's intelligent media matching (IMM) to further automate and streamline the process as illustrated in FIG. 4. The system allows users to quickly, and easily, build out any form of a branded page, from a company landing page, to an individual job page, to a full scale career site through a simple feature selection (e.g., drag and drop) interface. Users will create the job(s) template, or choose from existing templates, and link their branding (e.g., Cascading Style Sheets (CSS) files or any other styling language) at step 410 where they determine what will be displayed on the page(s), or within the job(s). Depending on the type of page being built, users can incorporate content and features including, but not limited to, information on the company, number of jobs to display per page (e.g., this is typically chosen when building a full scale career site), information describing the job, information and/or pictures of the hiring manager(s), links, pictures, videos, audio and other media content, commenting/posting sections, online/social connections to the company, sharing buttons, and embed buttons. The system's interface allows for quick additions of features, or rearrangement of features, within the page. Also, users will add co-creators at step 411. Then, either the linked applicant tracking system (ATS) will feed the job(s) descriptive text, or the creators will manually enter this information into the job(s) at step 412. The system will then scan the descriptive text, cross reference that text with the files, and tags, within the media library at step 413 by the IMM process. Once keywords, or phrases, within the job(s) descriptive content are matched with files in the media library, suggested media files are returned for insertion into the media sections of the job(s) at step 414. This process can be set to occur automatically, or users can manually select the media files to insert into the job(s).

The interaction of the media library, and the user's job pages, allows for quicker processing of job pages. The job page itself is structured such that the page does not house the media content locally, which reduces the data and allows for quicker processing. The structure of the media library, and the media identification (or IMM) system, allows for users to have job pages created and populated with minimal interaction, rather than having to manually insert media content locally on each page.

In addition, the system may quickly create specific pages 415 of jobs based on specific criteria by appending a URL with a certain syntax. For instance, if a user is at a job fair, and wants to quickly pull together a new page with jobs postings in that certain city, they can do so by typing in a specific URL and the page is pulled together on the fly. As an example, if a user's URL is company.companyname.com, and the user wants to create a page that quickly aggregates jobs in a certain city, they user would append the above URL with the following, company.companyname.com/recruiting/city/cityname. Further, the page is pulled together with a sign in feature allowing users to collect information from candidates that sign in in real time. Users can sign in with a manual input or with any social media account (e.g., FACEBOOK, LINKEDIN, TWITTER, INSTAGRAM, etc.). A folder is then created on the back end in the users account with the sign in information for later retrieval.

In this case, pages are created on the fly, very quickly, to target candidates at a particular event or location. The pages are created at a much quicker speed, in real time, and are readily available. For example, the system presents queries to a database of stored content and returns that content, thereby creating web pages with simple commands (e.g., typing in a particular URL syntax) input by a user. Based upon the structure of the URL that a user of the system inputs, a page is created that pulls together relevant media based on job department, location, and/or role that is the subject of the recruiting.

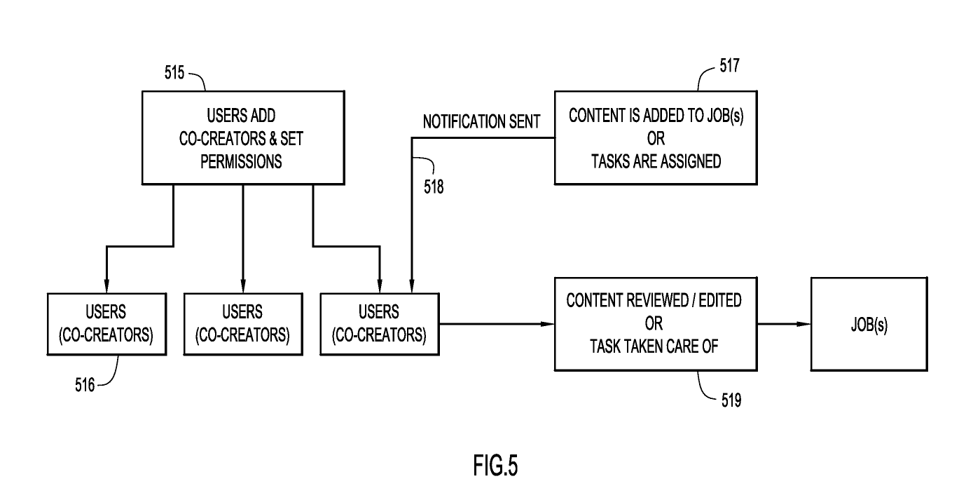

As mentioned previously, during the job(s) creation process users can add co-creators. Adding co-creators allows users to, among other things, share/assign tasks, crowd-source ideas and have more participants for content review as illustrated in FIG. 5. When users add co-creators, they will also set access/permissions for each co-creator at step 515. These permissions can range from full editing authority to task specific or review only authority and/or any permissions deemed necessary. Then, when things such as new content are added, or tasks are assigned at step 517, a notification is sent to the co-creators at step 518. Users will set/enable the types of notifications, and timing (e.g., push or pull, email, text etc., real time or scheduled summaries) for when there is new content/media added, media is uploaded to the library for potential use, a task is assigned, something requires review/edits, etc. Also, the sender can display priority levels within the notification itself. The co-creators 516 receiving the notification will then review, edit or take care of the assigned task at step 519.

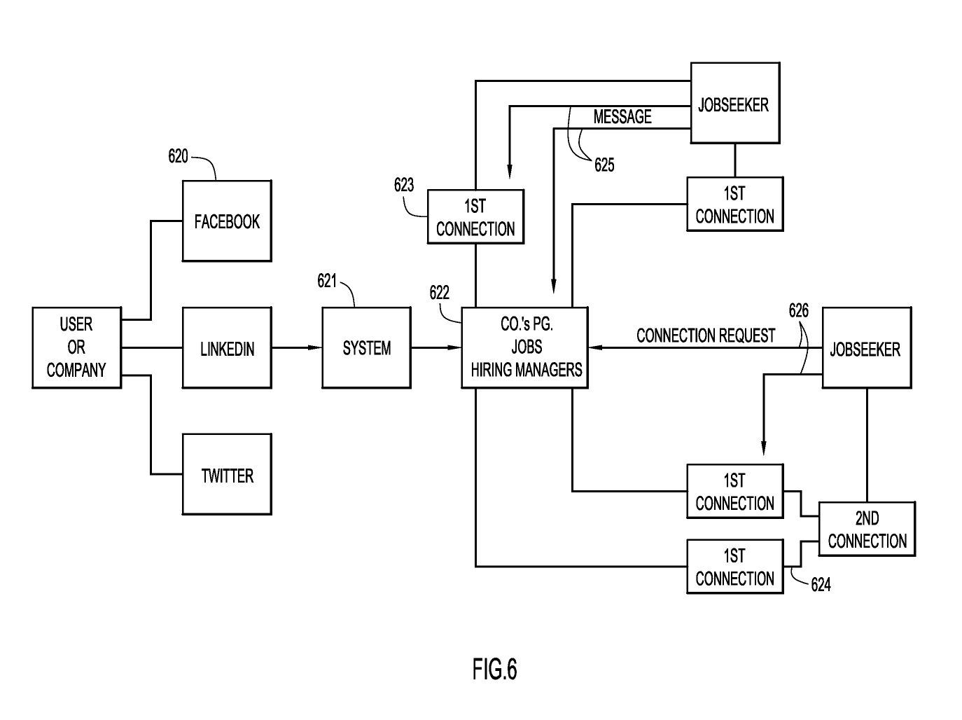

Online/social networks may be linked to the system, and job(s) as illustrated in FIG. 6. Accounts linked to the system, or job(s), can be that of the company itself, the hiring manager, co-creators or other employees, and can be used for a variety of purposes, such as communication, connectivity, dissemination/sharing, etc. Users link their online/social networks (e.g., FACEBOOK, LINKEDIN, TWITTER, INSTAGRAM, etc.) either to the system shown at step 620, which can then be applied to all job(s) at step 621, or users can link their networks to specific job(s) shown at step 622. Connecting online/social networks to the system's job(s) allows the user to display connections people have to the company and/or position and/or hiring manager shown at step 623. Thus, the users can browse their connections, and also see second, third etc. degree connections to the company, hiring manager(s) or job(s) shown at step 624. This connectivity also allows users to message those connections displayed, or the hiring manager, through the system at step 625. Users can also request connections of people connected to the company, or the hiring manager directly, through the system at step 626.

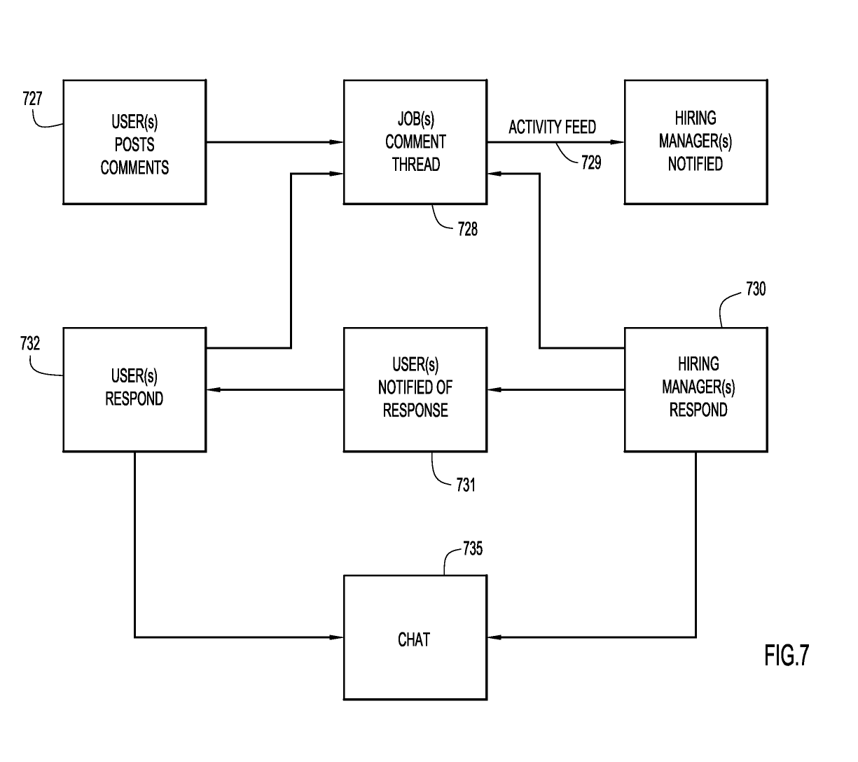

The system includes an interactive commenting/posting/Q&A/chat feature as illustrated in FIG. 7. This feature allows users to communicate directly with the hiring manager, or other users, directly through the system and view the already posted comments/questions (e.g., within the job(s) themselves). Users simply post their comment/question at step 727, which is added to the comment thread at step 728. Hiring managers, or the job(s) creators, receive notice of the posting through an activity feed at step 729. The hiring managers, or job(s) creators, can then respond to the posting at step 730. If users have notifications turned on, they will receive notice of the hiring manager's, or job(s) creator's, response at step 731 and have the ability to respond at step 732. The system allows all users (e.g., hiring managers, job(s) creators, jobseekers etc.) to enable, and set notification preferences related to the comment posting. Users can set things such as, but not limited to, their desired communication medium and whether they are real time or summary notifications.

In addition, the system further allows users to create group chats 735. The group chats allow the hiring manager to set specific dates/times where candidates can sign in and interact directly with the hiring manager and one another.

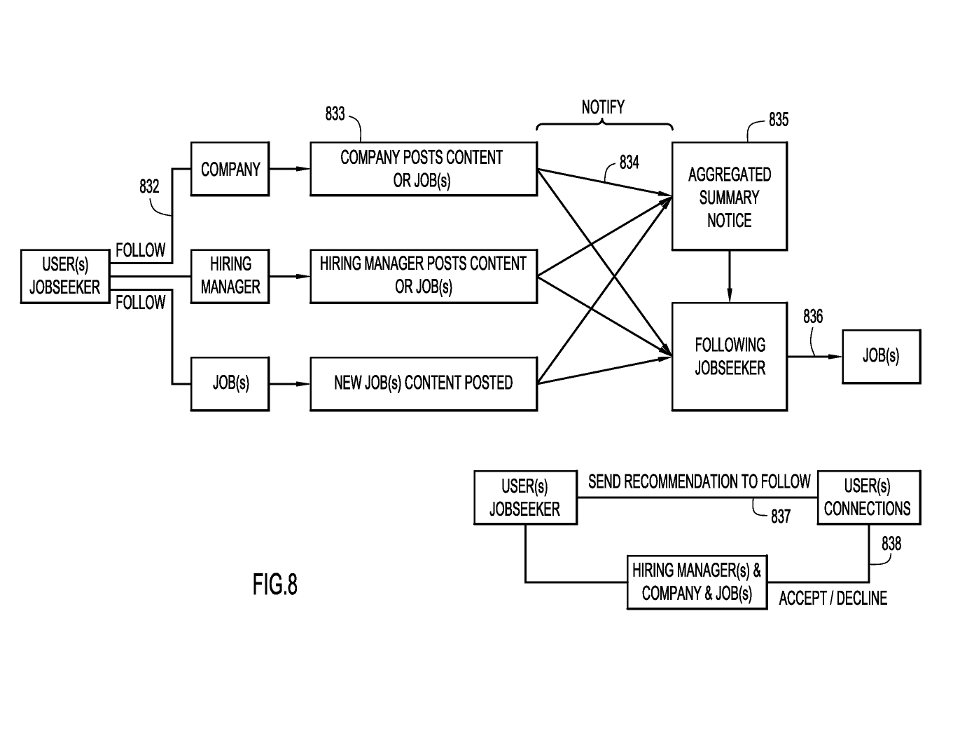

The system tracks job(s), companies or specific hiring managers as illustrated in FIG. 8. Users elect who to track or follow at step 832. When those that the are being tracked post new content, or job(s), at step 833 the following user can be notified in real time shown at step 834. The system allows users to enable/set, notification preferences similar to those discussed above for the description of comment posting (FIG. 7). Therefore, the tracking user can elect to receive their notifications in an aggregated summary format as well shown at step 835. The tracking user can then go view the new job(s) and/or content at step 836. Users also have the ability to send recommendations of companies, hiring managers or job(s) to track or follow to other users at step 837. Those receiving the recommendations can then view the suggestion, and accept or decline, the recommendation at step 838. The recommendation can be accepted directly on the destination page, or within the message sent.

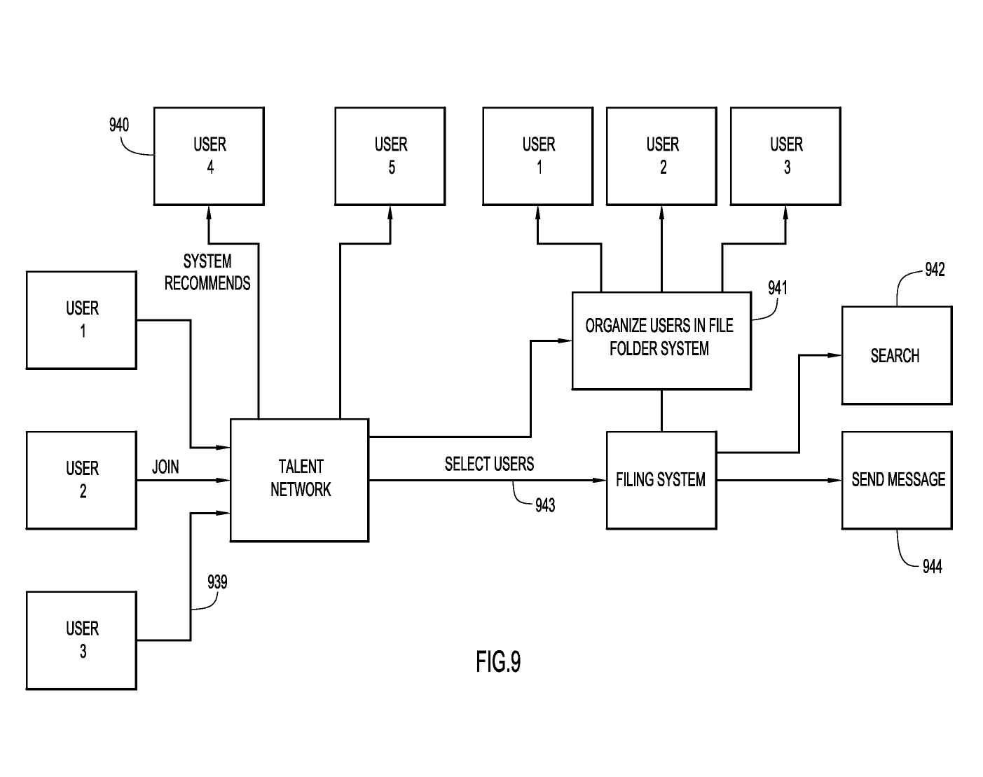

The system allows users to build out, and people to join, specific talent networks as shown in FIG. 9. People simply click a button to join a talent network at step 939. The system also makes recommendations, based on information known about users through their social or other networks/profiles, to both companies and users with suggested users and talent networks respectively that are appropriate to join at step 940. Once users join a talent network, the system, and talent network owners, then organize those users by things such as resume, background, skills, etc. at step 941. The talent network is therefore searchable by keywords which are matched with user's resumes, backgrounds, skills etc. at step 942. The talent network's organizational filing system allows for messages to be sent to specific groups within the talent network quickly and easily. To send a message through the system, talent network owners select the folders containing the targeted users at step 943. Once the folder is selected, talent network owners simply send their desired message, or content, at step 944.

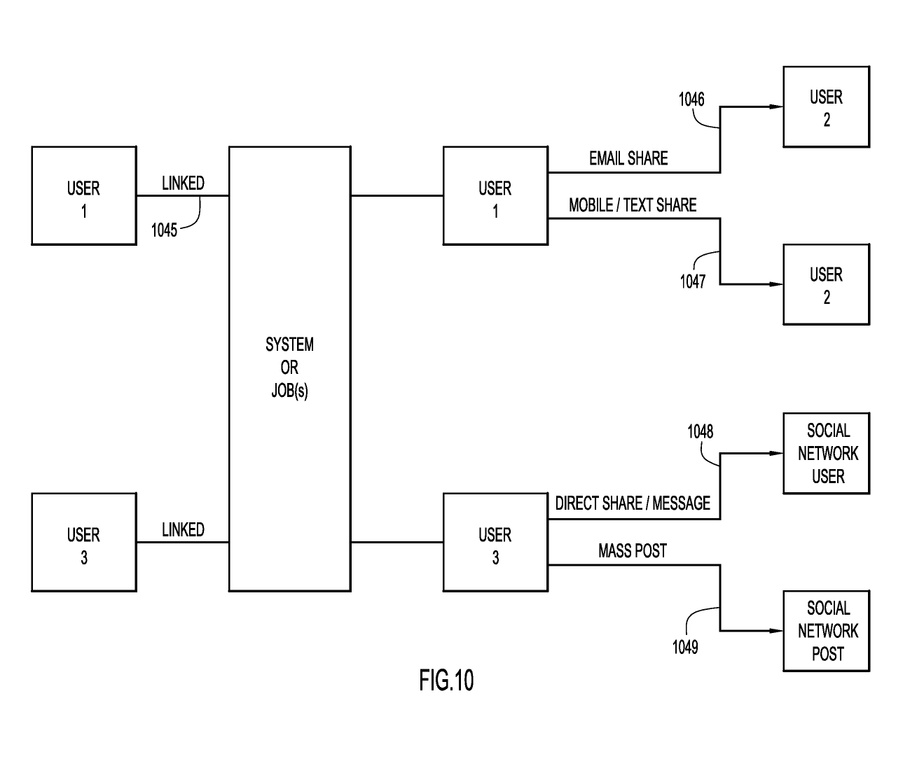

Job(s) can be distributed quickly through the online/social sharing component of the system as illustrated in FIG. 10. However, job(s) are not the only thing that users have the ability to share through the system. Users can also share things such as, but not limited to, company pages, hiring manager profiles, etc. As stated previously, users can be linked to the system, or the job(s), via their online/social networks shown at step 1045. The system allows users to distribute/share job(s) through a variety of different manners. Some of the main ways users can share job(s) are through email messages shown at step 1046, text/mobile sharing shown at step 1047 and direct messaging through online/social networks shown at step 1048. The messaging can also enable a user to quickly ask, or recommend, a job be shared with other people's social networks. The user simply shares the job with someone and a message is sent with embedded links to quickly share the job from within the message throughout a user's social networks (e.g. FACEBOOK, LINKEDIN, TWITTER, INSTAGRAM, etc.). For instance, if a user wants to drive more traffic to a particular job, he/she can share the job with colleagues etc., asking them to disseminate through their social networks.

Alternatively, users can do mass sharing through posts to their networks shown at step 1049. Further, if platforms have specified templates for multi-media sharing posts (e.g., TWITTER cards) the system will use its analytics, and tagging functions, to either suggest, or automatically populate these multi-media sharing posts.

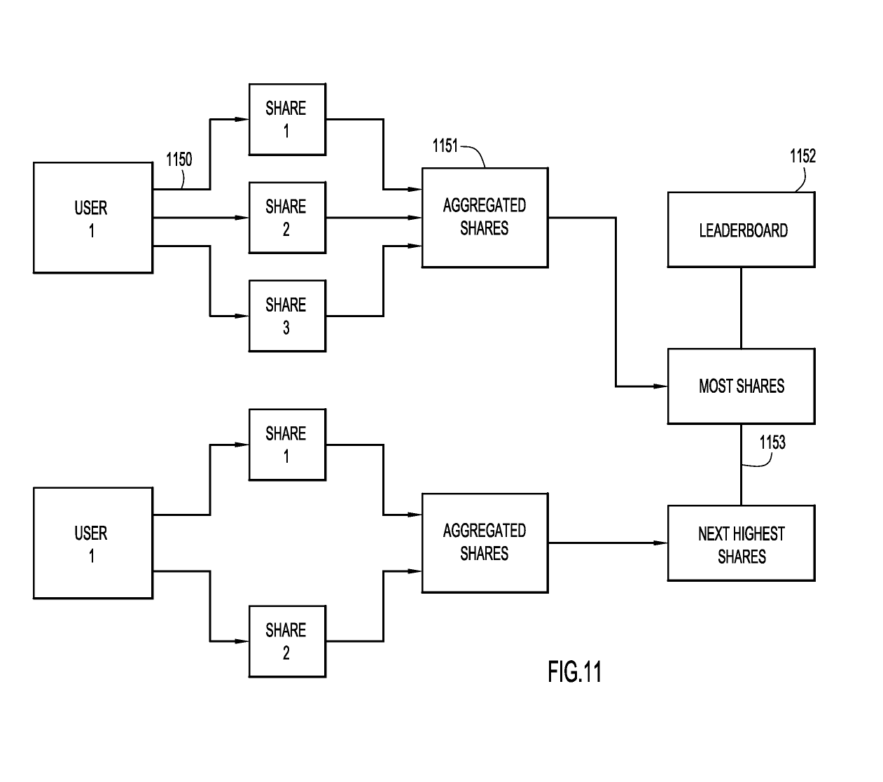

The system further includes a gamification or competition component as illustrated in FIG. 11. By gamifying functions of the system, such as the sharing component, it creates a friendly competition amongst those sharing the job(s). The example used in this illustration is the system's leaderboard, which demonstrates the user's reach/influence. Users share the job(s) at step 1150. Those shares are tracked, and then aggregated at step 1151. Users are then displayed, based on their shares, through the leaderboard at step 1152. The sharers are cascaded down the leaderboard, from most shares to least, at step 1153.

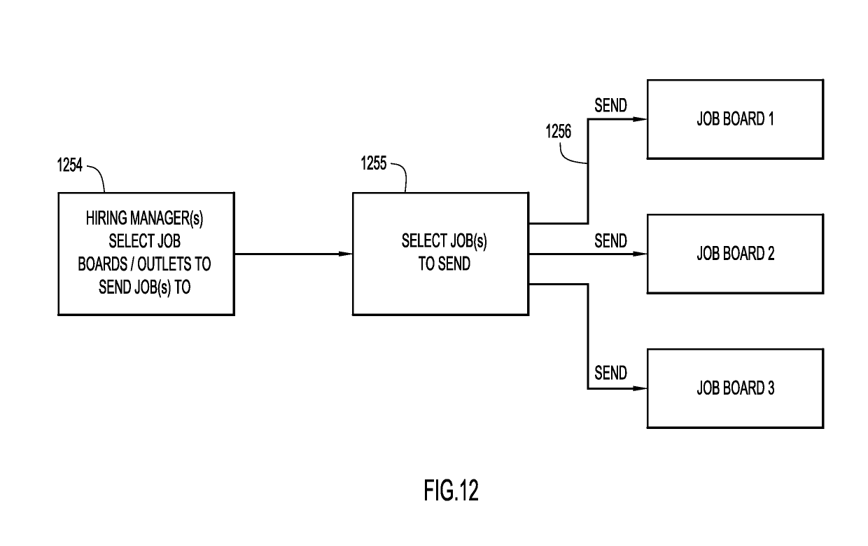

The system syndicates/disseminates the job(s) across various participating, or open, platforms as illustrated in FIG. 12. Dissemination can be done both as a manual, or automated, process as determined by the user. Users select the job boards/outlets to send the job(s) to at step 1254. Users then select the job(s) to be sent to the outlets at step 1255. These selections can be applied to all job(s), or can be selected specially for certain job(s). Once the selections are made, the system sends the job(s) to the chosen outlets at step 1256. This type of dissemination allows the system to act as a hub to either automatically, or manually, post job(s) to other job boards or platforms.

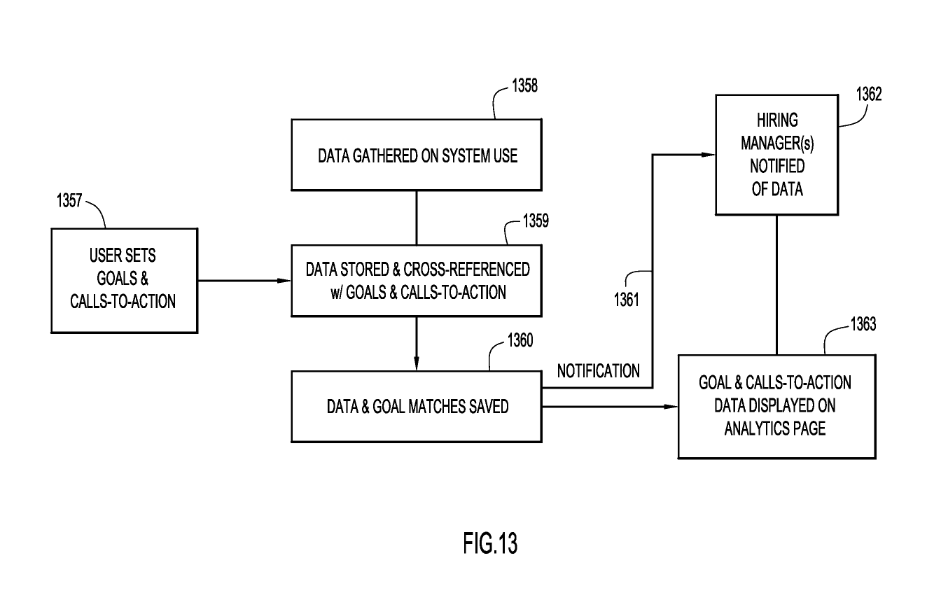

The system also provides analytics on job(s) as illustrated in FIG. 13. Users can measure, track, and view these analytics on an aggregated basis (e.g., all job(s)) or on an individual job(s) basis. The system tracks, and displays, data on key calls-to-actions or other goals set by the users, such as, but not limited to, applications, talent network joins, comments, time spent on job(s) pages, video plays, image views, online/social connections (reach) of visitors to the job(s), follows, online/social shares, etc. Also tracked is demographic data and behavior (e.g., mobile vs. desktop, laptop vs. desktop, browser, geography, time spent on job(s) or specific parts of the page such as video, traffic source, etc.).

The analytics also contain specific track to hire data. The system tracks all traffic to job postings, online and offline, and allows user to view trend-line rankings of where conversion to applications and hires originates from. The system tracks online traffic and then looks at data from the application tracking system (ATS) (e.g., did they apply?, did they interview?, did they get hired?) to give a complete picture of where candidates began and where they ended. This data allows users to determine and refine where their recruiting efforts/dollars are best spent. Users can further isolate specific trend-lines, by using keywords and date ranges. For instance, if a user wants to isolate and view the social sharing trend for a certain date range he/she can easily do so.

Users establish/set goals, in the system at step 1357. As users interact with the system, data points surrounding that activity are gathered at step 1358. The system activity data points are then stored and cross-referenced with the established goals, at step 1359. The system then matches the data points with the established goals at step 1360, and sends out the appropriate notifications at step 1361.

Similar to other components of the system, users can enable/set various types of notifications, and establish permissions for who has access to the analytics. Further, users can set preferences for their desired notification method and timing (e.g., push or pull, email, text, etc., real time or scheduled summaries) for when there is new analytic data requiring attention, or for review. The hiring managers, or co-creators, are notified of the data point matches at step 1362, and the goal data is then displayed in a user friendly format on their analytics dashboard at step 1363.

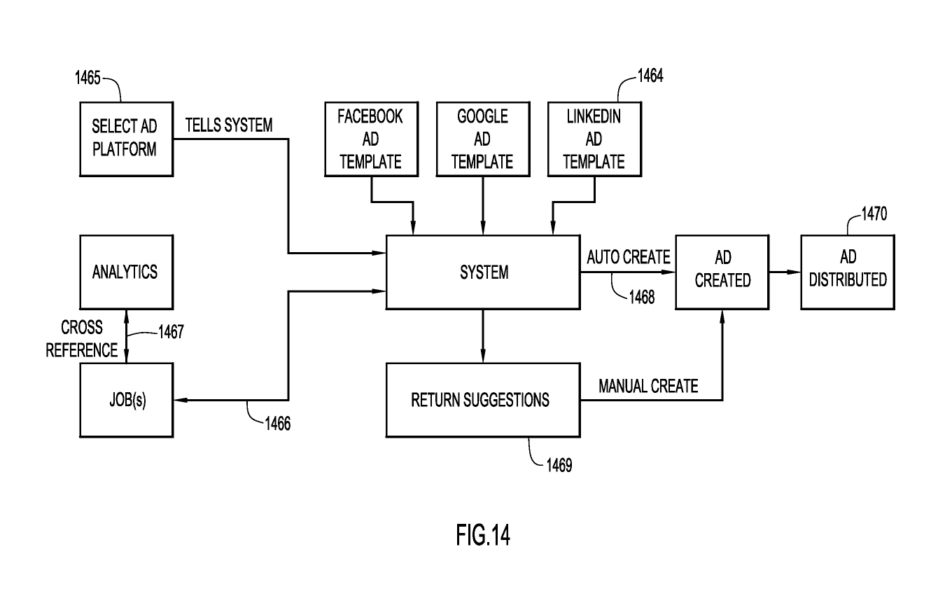

The system utilizes the job(s) analytics to allow users to publish advertisements (based on existing content within pages created with the system) across various advertisement platforms as shown in FIG. 14. The system has pre-programed advertisement templates (e.g., number of characters of text, type, number and size of media files such as video and pictures etc.) for various advertisement platforms shown at step 1464. Users then select the advertisement platform(s) for which they wish to create advertisements for submission at step 1465. The system then scans the job(s) content at step 1466, cross-references it with the job(s) analytics (e.g. most viewed pictures etc.) at step 1467 and either auto-populates the advertisement's content at step 1468 or returns suggested content to review at step 1469 for manual submission. The advertisement is then distributed to the appropriate advertisement platform at step 1470. This intelligent advertisement creation feature allows system users to quickly and easily turn their job(s) into advertisements to reach a broader group of their target audience.

It is to be understood that the embodiments described above, and illustrated in the drawings, represent only some of the many ways the system and method for creating and disseminating online job descriptions can be implemented. The number of users represented in the drawings is simply for illustrative purposes, and is not indicative of the number of users that can utilize the system. Further, the system can be utilized by anyone, and is not to be limited to company recruiting (e.g. the system could be used for athletic recruiting, team building etc.). Further, the system need not be used as a whole, and can be utilized for its individual parts. For instance, a user could use the system just for it's talent network, its advertisement creator, etc.

The environment of the present invention embodiments may include any number of computer or other processing systems or devices (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system or device (e.g., desktop, laptop, PDA or tablet, mobile devices, computing node, etc.), and may include any commercially available operating system and any combination of commercially available and custom software (e.g. browser software, communications software, server software, recruiting software of the present invention embodiments, etc.). These systems may include any types of displays and input devices (e.g., virtual or physical keyboard, mouse, voice recognition, touch screen, etc.) to enter and/or view information.

It is to be understood that the software for the computer system of the present invention embodiments (e.g., server systems, etc.) may be implemented in any desired computer language and could be developed by one of ordinary skill in the computer arts based on the functional descriptions contained in the specification and flow charts illustrated in the drawings. In other words, the type of programs and programming languages are not restricted to the use of any particular language. The various modules may be implemented by any combination of any quantity of software and/or hardware modules or units. When implemented as software modules or units, the various modules or units may reside within memory of the server computer system for execution by one or more processors of the server computer system.

Further, any references herein of software performing various functions generally refer to computer systems or processors performing those functions under software control. The computer systems of the present invention embodiments may alternatively be implemented by any type of hardware and/or other processing circuitry. The various functions of the computer systems may be distributed in any manner among any quantity of software modules or units, processing or computer systems and/or circuitry, where the computer or processing systems may be disposed locally or remotely of each other and communicate via any suitable communications medium (e.g., LAN, WAN, Intranet, Internet, hardwire, modem, connection, wireless, etc.). For example, the functions of the present invention embodiments may be distributed in any manner among the end-user and server systems. The software and/or algorithms described above and illustrated in the flow charts may be modified in any manner that accomplishes the functions described herein. In addition, the functions in the flow charts or descriptions may be performed in any order that accomplishes a desired operation.

The software of the present invention embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium. The software of the present invention embodiments may further be downloaded (e.g., in the form of carrier waves, packets, etc.) to systems via a network or other communications medium.

The communication network may be implemented by any quantity of any type of communications network (e.g., LAN, WAN, Internet, Intranet, VPN, etc.). The computer systems of the present invention embodiments (e.g., end-user systems, server systems, etc.) may include any conventional or other communications devices to communicate over the network via any conventional or other protocols. The computer systems (e.g., end-user system, server systems, etc.) may utilize any type of connection (e.g., wired, wireless, etc.) for access to the network.

The database may be implemented by any quantity of any conventional or other database or storage unit, may store any desired information, and may be local to or remote from the server and/or user computer systems.

The present invention embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, virtual or physical keyboard, touch screen, etc.). The interface screens may include any suitable actuators (e.g., links, tabs, etc.) to navigate between the screens in any fashion.

What is claimed is:

1. A system for distributing job information comprising:
at least one processor configured to:
create a job object for requesting applicants for a job, wherein the job object includes one or more multimedia objects retrieved from a media library for job objects;
link one or more networks to the system to provide destinations for the job object and communications with the applicants; and
distribute the job object to selected destinations from the networks.

2. The system of claim 1, wherein creating a job object further comprises:
assigning access privileges to a plurality of users for accessing the job object; and
transmitting notifications to the plurality of users in response to access of the job object.

3. The system of claim 1, wherein creating a job object further comprises:
comparing information within the job object to the multimedia objects in the media library; and
retrieving multimedia objects for the job object based on the comparison.

4. The system of claim 1, wherein creating a job object further comprises:
importing information for the job object from job postings of an external applicant tracking system of an entity.

5. The system of claim 1, wherein the one or more networks include a social network, and distributing the job object further comprises:
distributing the job object through the social network to user connections within the social network.

6. The system of claim 1, wherein the at least one processor is further configured to:
establish interactive communication with the applicants via one of a posting mechanism and a chat mechanism.

7. The system of claim 1, wherein the at least one processor is further configured to:
track one or more items from a group of a selected entity and job object, and transmit a notification in response to new content for the tracked item.

8. The system of claim 1, wherein the at least one processor is further configured to:
create a talent network of applicants, wherein the applicants are arranged according to attributes of the applicants; and
access the talent network to identify applicants satisfying desired criteria.

9. The system of claim 1, wherein the at least one processor is further configured to:
conduct a competition by tracking distribution of job objects and providing a ranking of competition participants based on quantities of job object distributions by those participants.

10. The system of claim 1, wherein the at least one processor is further configured to:
determine analytics of specified events and attributes pertaining to job objects; and
assign access privileges specifying access to particular levels of details of the analytics.

11. The system of claim 1, wherein the at least one processor is further configured to:
create an advertisement for the job object and publish the advertisement across one or more platforms.

12. A method of distributing job information comprising:
creating, via a computer system, a job object for requesting applicants for a job, wherein the job object includes one or more multimedia objects retrieved from a media library for job objects;
linking one or more networks to the computer system to provide destinations for the job object and communications with the applicants; and
distributing the job object to selected destinations from the networks.

13. The method of claim 12, wherein creating a job object further comprises:
assigning access privileges to a plurality of users for accessing the job object; and
transmitting notifications to the plurality of users in response to access of the job object.

14. The method of claim 12, wherein creating a job object further comprises:
comparing information within the job object to the multimedia objects in the media library; and
retrieving multimedia objects for the job object based on the comparison.

15. The method of claim 12, wherein creating a job object further comprises:
importing information for the job object from job postings of an external applicant tracking system of an entity.

16. The method of claim 12, wherein the one or more networks include a social network, and distributing the job object further comprises:
distributing the job object through the social network to user connections within the social network.

17. The method of claim 12, further comprising:
establishing interactive communication with the applicants via one of a posting mechanism and a chat mechanism.

18. The method of claim 12, further comprising:
tracking one or more items from a group of a selected entity and job object, and transmitting a notification in response to new content for the tracked item.

19. The method of claim 12, further comprising:
creating a talent network of applicants, wherein the applicants are arranged according to attributes of the applicants; and
accessing the talent network to identify applicants satisfying desired criteria.

20. The method of claim 12, further comprising:
conducting a competition by tracking distribution of job objects and providing a ranking of competition participants based on quantities of job object distributions by those participants.

21. The method of claim 12, further comprising:
determining analytics of specified events and attributes pertaining to job objects; and
assigning access privileges specifying access to particular levels of details of the analytics.

22. The method of claim 12, further comprising:
creating an advertisement for the job object and publishing the advertisement across one or more platforms.
